(19) United States
(12) Patent Application Publication
(10) Pub. No.: US 2019/0036426 A1
(43) Pub. Date: Jan. 31, 2019

(54) MOTOR

(71) Applicant: NIDEC CORPORATION, Minami-ku Kyoto (JP)

(72) Inventors: Tomoyuki UMEDA, Minami-ku Kyoto (JP); Takayuki MIGITA, Minami-ku Kyoto (JP)

(21) Appl. No.: 16/148,177

(22) Filed: Oct. 1, 2018

Related U.S. Application Data
(63) Continuation of application No. PCT/JP2017/012201, filed on Mar. 25, 2017.

(30) Foreign Application Priority Data
Mar. 31, 2016 (JP) 2016-070268

(51) Int. Cl. H02K 11/40; H02K 1/18; H02K 1/32; H02K 3/52; H02K 5/173; H02K 5/22; H02K 7/08; H02K 7/14; H02K 11/30; H02K 21/16; F04D 19/00; F04D 29/18

(52) U.S. Cl. CPC H02K 11/40; H02K 1/185; H02K 1/32; H02K 3/522; H02K 5/1732; H02K 5/225; H02K 2211/03; H02K 7/14; H02K 11/30; H02K 21/16; F04D 19/002; F04D 29/181; H02K 2203/06; H02K 7/083

(57) ABSTRACT

A motor may include a rotor rotating on a central axis; a stator located radially outside the rotor; a bearing supporting the rotor such that the rotor is rotatable with respect to the stator; and a holder that holds the stator. The stator may include a stator core; and a coil. The holder may include a cover disposed on an axially first side of the coil; and a bracket that is electrically connected to and fixed to the cover, is disposed on an axially second side of the coil, and is connectable to a ground. The holder may have an opening that penetrates the holder in a radial direction and is located between the axially first-side end of the coil and the cover, and an opening that penetrates the holder in the radial direction and is located between the axially second-side end of the coil and the bracket.

This application is a bypass continuation application of PCT Application No. PCT/JP2017/012201, filed Mar. 25, 2017, and claims the benefit of priority to Japanese Patent Application No. 2016-070268 filed on Mar. 31, 2016. The entire contents of each application are hereby incorporated herein by reference.

### FIELD

The present disclosure relates to a motor.

### BACKGROUND

Recently, a motor and a controller that controls the motor have been assembled into a single unit for the purpose of miniaturization. The unit into which the motor and the controller are assembled has a short distance between the motor and a control circuit board in the controller. Consequently, heat to be generated in driving the motor may adversely affect the operation of the controller.

For example, a known motor of an inner rotor type motor is cooled by means of an air flow to be generated upon rotation of a rotor.

Some of such motors include no housing for surrounding an outer periphery of a stator. The motor, which is not provided with a housing, improves air permeability and further reduces adverse effects due to heat from the motor. However, since the motor includes no housing, electromagnetic noise to be generated from a coil may adversely affect an electronic component outside the motor.

### SUMMARY

An exemplary motor according to the present disclosure includes: a rotor that rotates on a central axis; a stator that is located radially outside the rotor; a bearing that supports the rotor such that the rotor is rotatable with respect to the stator; and a holder that holds the stator. The stator includes: a stator core; and a coil that is formed of a conductive wire wound around the stator core. The holder includes: a cover that is disposed on an axially first side of the coil; and a bracket that is electrically connected to and fixed to the cover, is disposed on an axially second side of the coil, and is connectable to a ground. The holder has an opening that penetrates the holder in a radial direction and is located between the axially first-side end of the coil and the cover, and an opening that penetrates the holder in the radial direction and is located between the axially second-side end of the coil and the bracket.

An exemplary electric fan according to the present disclosure includes: the motor described above; and an impeller that is disposed on an axially first side of the motor and rotates on the central axis of the motor. The impeller includes: a tubular portion whose axially first side is closed, the tubular portion being provided to cover at least a part of the motor from a radially outer side of the motor; and a plurality of blades that are disposed on an outer periphery of the tubular portion and are arranged in a circumferential direction.

The above and other elements, features, steps, characteristics and advantages of the present disclosure will become more apparent from the following detailed description of the embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic plan view of an electric fan according to an embodiment of the present disclosure.

FIG. 2 is a schematic side view of the electric fan according to the embodiment of the present disclosure.

FIG. 3 is a schematic perspective view of a motor according to the embodiment of the present disclosure.

FIG. 4 is a schematic sectional view of the motor according to the embodiment of the present disclosure.

FIG. 5 is a schematic perspective view of a stator according to the embodiment of the present disclosure as seen from an axially second side.

FIG. 6 is a schematic perspective view of a bracket according to the embodiment of the present disclosure.

FIG. 7 is a schematic perspective view of a cover according to the embodiment of the present disclosure.

FIG. 8 is an enlarged schematic perspective view of a fixation portion of the cover according to the embodiment of the present disclosure.

FIG. 9 is a schematic plan view of a relationship between the stator and the cover according to the embodiment of the present disclosure.

### DETAILED DESCRIPTION

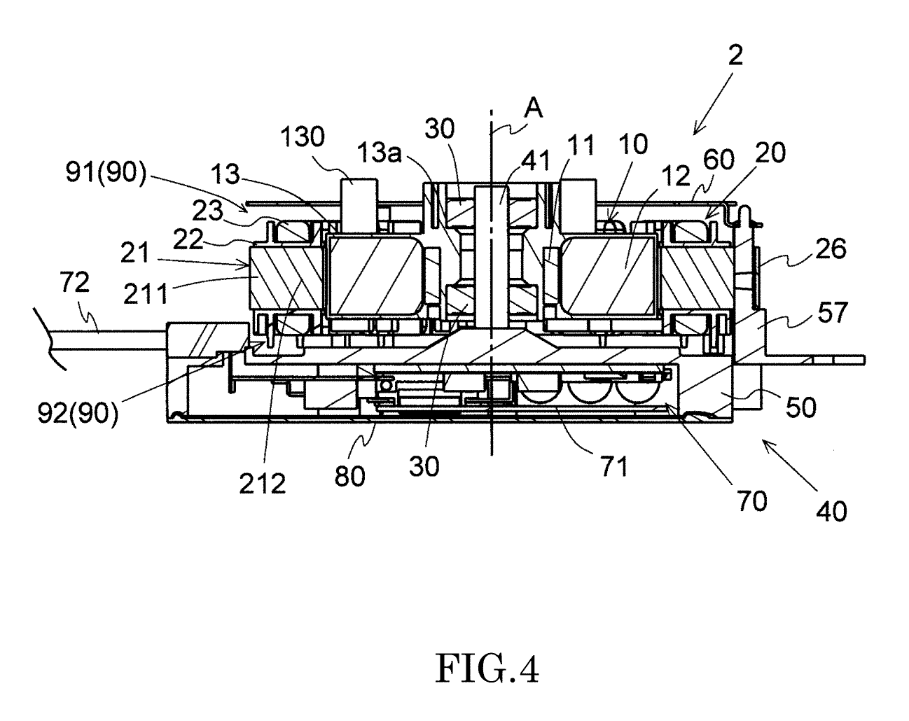

With reference to the drawings, a specific description will be given of an embodiment of the present disclosure. As used herein, the terms “axial direction”, “axial”, and “axially” each represent a direction along which a central axis A of a motor (see FIG. 4) extends. In addition, the terms “radial direction”, “radial”, and “radially” and the terms “circumferential direction”, “circumferential”, and “circumferentially” respectively represent a radial direction from the central axis A of the motor and a circumferential direction about the central axis A of the motor. The same applies for an impeller to be mounted to the motor.

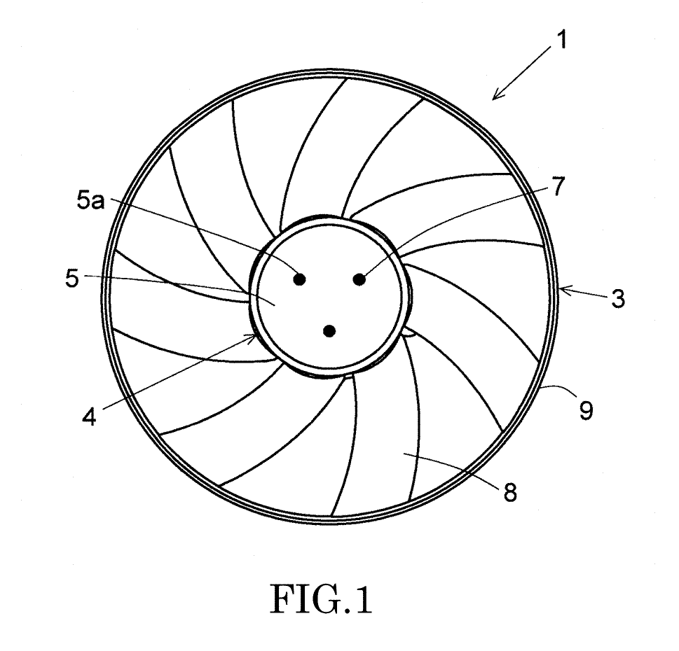

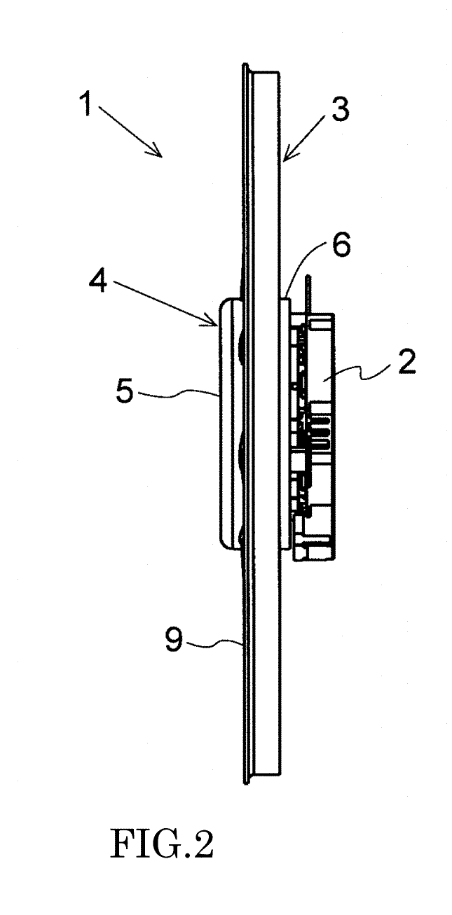

FIG. 1 is a schematic plan view of an electric fan 1 according to an embodiment of the present disclosure. FIG. 2 is a schematic side view of the electric fan 1 according to the embodiment of the present disclosure. The electric fan 1 includes a motor 2 and an impeller 3. The motor 2 has rotor protrusions 130 (to be described later). The impeller 3 is mounted to the motor 2 via the rotor protrusions 130. In the present embodiment, the impeller 3 is directly mounted to the rotor protrusions 130. Alternatively, the impeller 3 may be indirectly mounted to the rotor protrusions 130. The impeller 3 is disposed on one side of the motor 2 in the axial direction and rotates on the central axis A. In the following description, a side, on which the impeller 3 is disposed, of the motor 2 is referred to as an axially first side, and the opposite side is referred to as an axially second side.

The impeller 3 includes a tubular portion 4 whose axially first side is closed. The tubular portion 4 is provided to cover at least a part of the motor 2 from a radially outer side of the motor 2. In the present embodiment, the tubular portion 4 includes a disk portion 5 that expands in a direction perpendicular to the axial direction. The disk portion 5 is located on an axially first-side end of the tubular portion 4. The tubular portion 4 includes a cylindrical portion 6 that extends from the disk portion 5 toward the axially second side. The cylindrical portion 6 is located radially outside the motor 2. The central axis A of the motor 2 coincides with the center of the disk portion 5 as seen in axial plan view.

The disk portion 5 has a plurality of screw holes 5a that are located radially outside the center of the disk portion 5. Each of the screw holes 5a penetrates the disk portion 5 in the axial direction. In the present embodiment, the number of screw holes 5a is three. The three screw holes 5a are arranged at equal intervals in the circumferential direction. A screw 7 is inserted into each screw hole 5a. The screws 7 are respectively mounted to the rotor protrusions 130 of the motor 2. The disk portion 5 is secured to the motor 2 with the screws 7, so that a part of the motor 2 in the axial direction is covered with the cylindrical portion 6.

The impeller 3 includes a plurality of blades 8 and a ring portion 9. The blades 8 are disposed on an outer periphery of the tubular portion 4 and are arranged at equal intervals in the circumferential direction. Each of the blades 8 extends radially outward from the cylindrical portion 6. The ring portion 9 is connected to a radially outer end of each blade 8. In the present embodiment, the blades 8 are integrated with the tubular portion 4 and the ring portion 9. In the present embodiment, the number of blades 8 is seven. However, these configurations are merely exemplary. For example, the tubular portion 4, the blades 8, and the ring portion 9 may be separated from one another. In addition, the number of blades 8 may be appropriately changed.

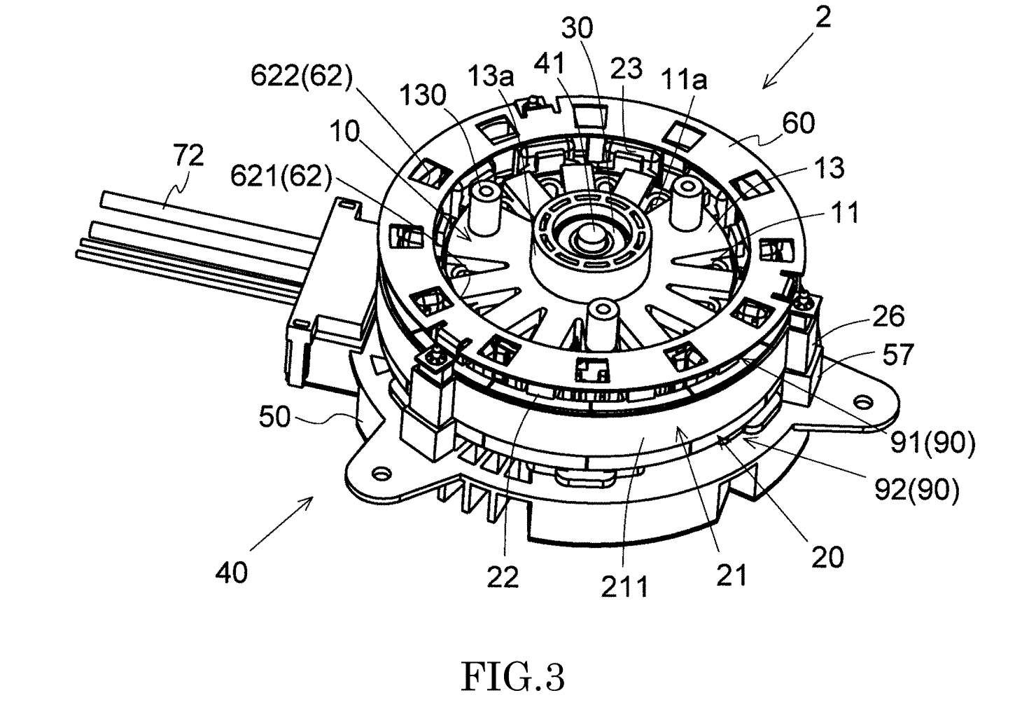

FIG. 3 is a schematic perspective view of the motor 2 according to the embodiment of the present disclosure. FIG. 4 is a schematic sectional view of the motor 2 according to the embodiment of the present disclosure. Specifically, FIG. 4 illustrates a longitudinal section including the central axis A. The motor 2 is a motor of an inner rotor type. The motor 2 includes a rotor 10, a stator 20, bearings 30, and a holder 40.

The rotor 10 rotates on the central axis A. The rotor 10 includes a rotor core 11, a plurality of magnets 12, and a resin portion 13. In the present embodiment, the rotor core 11 is formed of a stack of magnetic steel sheets. Alternatively, the rotor core 11 may be formed of a plurality of core pieces bonded together. The rotor core 11 has a plurality of rotor through-holes 11a that penetrate the rotor core 11 in the axial direction. The rotation of the impeller 3 causes air to flow through each rotor through-hole 11a. The motor 2 is thus cooled. In addition, the rotor through-holes 11a contribute to a reduction in weight of the rotor core 11, which improves the efficiency of the motor 2. Each of the magnets 12 is a permanent magnet. A single annular magnet may be used instead of the plurality of magnets 12.

The resin portion 13 is provided to cover at least a part of the rotor core 11. The resin portion 13 is provided to cover at least a part of each magnet 12. The resin portion 13 fixes the magnets 12 to the rotor core 11. However, the magnets 12 may be fixed to the rotor core 11 by any other means in addition to the resin portion 13. For example, the magnets 12 may be fixed to rotor core 11 with an adhesive.

The stator 20 is located radially outside the rotor 10. The stator 20 includes a stator core 21, insulators 22, and coils 23. In the present embodiment, the stator core 21 is formed of a stack of magnetic steel sheets. Alternatively, the stator core 21 may be formed of a plurality of core pieces bonded together. The stator core 21 has an inner peripheral face that faces an outer peripheral face of the rotor 10. The stator core 21 includes a core back 211 that is formed in a ring or substantially ring shape, and a plurality of teeth 212 that protrude radially inward from the core back 211. The teeth 212 are arranged at equal intervals in the circumferential direction. The teeth 212 are respectively covered with the insulators 22. Each of the insulators 22 is formed of an insulating member (e.g., a resin). The coils 23 are formed of conductive wires wound around the teeth 212 via the insulators 22.

The bearings 30 support the rotor 10 such that the rotor 10 is rotatable with respect to the stator 20. In the present embodiment, each of the bearings 30 is a ball bearing. The bearings 30 are spaced apart from each other in the axial direction. The resin portion 13 includes bearing holders 13a that respectively hold the bearings 30. Each of the bearing holders 13a is located radially inside the resin portion 13. Specifically, the bearing holders 13a are spaced apart from each other and are respectively disposed on axially first and second sides of the resin portion 13. Each bearing 30 may be any other bearing in addition to the ball bearing. Each bearing 30 may be, for example, a sleeve bearing.

The holder 40 supports the stator 20. The holder 40 has, on its axially second side, a bracket 50. The bracket 50 is formed in a circular or substantially circular shape as seen in axial plan view. The bracket 50 has, on its central portion, a shaft 41 fixed thereto. The shaft 41 extends in the axial direction. The central axis A coincides with the center of the shaft 41 as seen in axial plan view. The bearings 30 are located between the rotor 10 and the shaft 41. The rotor 10 is rotatable with respect to the shaft 41.

A controller 70 is disposed on an axially second side of the bracket 50. The controller 70 controls the motor 2 that is driven. The controller 70 includes a control circuit board 71 on which a control circuit is mounted. In the present preferred embodiment, the control circuit board 71 is disposed perpendicularly to the central axis A. The control circuit board 71 may tilt relative to the central axis A. A plurality of wires 72 are electrically connected to the control circuit board 71. The wires 72 are drawn radially outward from the bracket 50. A lid 80 is disposed on an axially second side of the control circuit board 71. The lid 80 is provided to cover the control circuit board 71. The lid 80 is supported by the bracket 50.

The holder 40 has, on its axially first side, a cover 60. In the present embodiment, the cover 60 is formed of a circular ring-shaped or substantially circular ring-shaped member. The shape of the cover 60 is not particularly limited. For example, the cover 60 may be formed in a polygonal or substantially polygonal shape. The cover 60 is located radially outside the rotor 10. Moreover, the cover 60 is disposed on an axially first side of the stator 20. The cover 60 is provided to cover the coils 23. The rotor 10 includes at least one rotor protrusion 130 that protrudes beyond the cover 60 toward the axially first side. The tubular portion 4 of the impeller 3 is mounted to the rotor protrusion 130. The impeller 3 thus rotates together with the rotor 10. In the present embodiment, the tubular portion 4 is fixed to the rotor protrusion 130 with a screw 7. Alternatively, the tubular portion 4 may be fixed to the rotor protrusion 130 by any other method such as welding. Since the impeller 3 is mounted to the rotor 10 via the rotor protrusion 130, a space through which air flows is defined between the impeller 3 and the rotor 10.

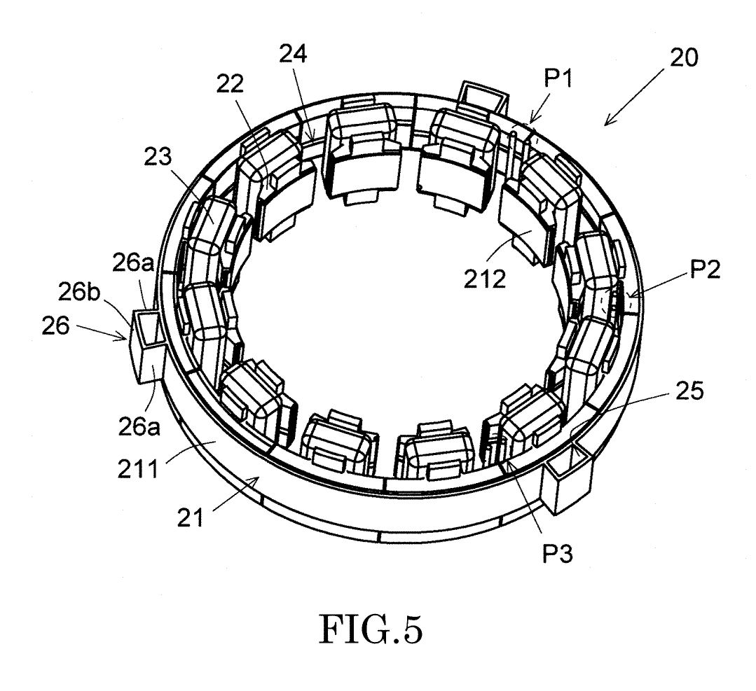

FIG. 5 is a schematic perspective view of the stator 20 according to the embodiment of the present disclosure. In the present embodiment, the number of teeth 212 is 12. Each insulator 22 is provided to cover axially first and second sides of a corresponding one of the teeth 212. Conductive wires are wound around the teeth 212 covered with the insulators 22. The coils 23 are thus formed. The coils 23 are arranged in the circumferential direction. In the present embodiment, the number of coils 23 is 12. A slot 24 is defined between adjoining two of the coils 23. Each slot 24 corresponds to a clearance between adjoining two of the coils 23. In other words, each slot 24 corresponds to a clearance between adjoining two of the teeth 212.

Specifically, the conductive wires wound around the teeth 212 include three conductive wires corresponding to the U phase, the V phase, and the W phase. One of the three conductive wires is wound around each of the teeth 212. The coils 23 are thus formed. In the present embodiment, the coils 23 include four U-phase coils, four V-phase coils, and four W-phase coils.

The conductive wires that form the coils 23 of the respective phases each have two ends that are electrically connected to the control circuit board 71. In the present embodiment, the conductive wires are drawn toward the control circuit board 71 at a first lead-out position P1, a second lead-out position P2, and a third lead-out position P3. The three lead-out positions P1 to P3 are spaced apart from one another in the circumferential direction. Specifically, the lead wires are drawn toward the axially second side at each of the lead-out positions P1 to P3. The lead-out positions P1 to P3 are respectively at three of the slots 24.

The stator core 21 has connection holes 25 that penetrate the stator core 21 in the axial direction. The stator core 21 has protrusions 26 that protrude radially outward from an outer peripheral face of the stator core 21. The protrusions 26 define the connection holes 25. Each of the protrusions 26 is formed in a U or substantially U shape as seen in axial plan view. Specifically, each of the protrusions 26 includes a pair of protruding walls 26a and a connection wall 26b. Each of the protruding walls 26a protrudes from an outer peripheral face of the core back 211 in the radial direction. The protruding walls 26a are spaced apart from each other in the circumferential direction. The connection wall 26b extends in the circumferential direction and connects the protruding walls 26a to each other. Each of the connection holes 25 is defined by the two protruding walls 26a and the connection wall 26b. In the present embodiment, the protruding walls 26a and the connection wall 26b are each formed in a rectangular plate or rectangular plate shape. The three protrusions 26 are arranged at equal intervals in the circumferential direction. The number of protrusions 26 may be larger than three or may be smaller than three.

The holder 40 includes the bracket 50 and the cover 60. A specific description will be given of each of these components.

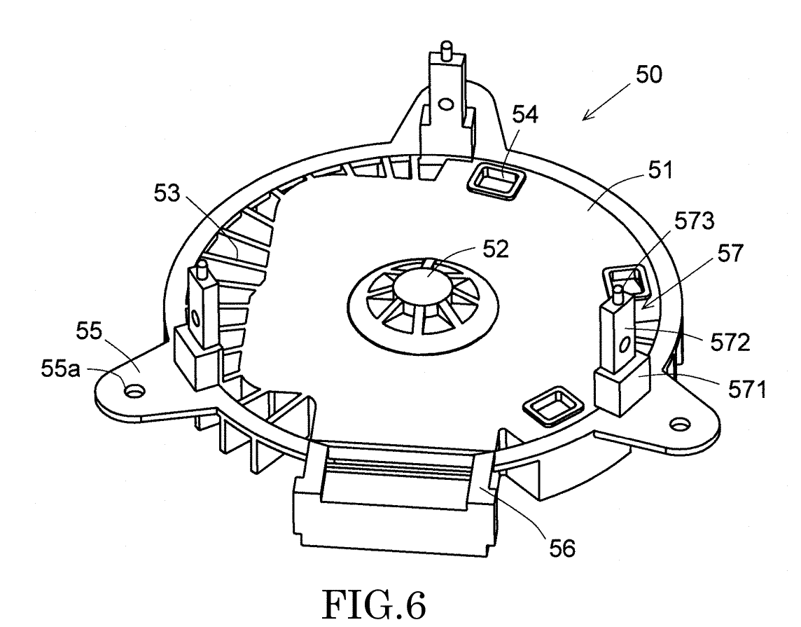

FIG. 6 is a schematic perspective view of the bracket 50 according to the embodiment of the present disclosure. The bracket 50 is electrically connected to and fixed to the cover 60. The bracket 50 is connectable to the ground. The bracket 50 is formed of a metal member. In cases where the electric fan 1 is mounted on, for example, an automobile, the bracket 50 is electrically connected to, for example, the body of the automobile.

The bracket 50 includes a main body 51 that is formed in a disk or substantially disk shape. The main body 51 includes a bump 52 that is formed in a conical or substantially conical shape. The bump 52 is located at a center of an axially first-side end face of the main body 51. In the present embodiment, the bump 52 is integrated with the main body 51. The bump 52 supports the shaft 41. The main body 51 has, on its outer edge, a plurality of air vents 53. Each of the air vents 53 penetrates the main body 51 in the axial direction. In the present embodiment, the air vents 53 are not formed all around the main body 51 in the circumferential direction, but are formed approximately halfway around the main body 51 in the circumferential direction. As seen from the axially first side, specifically, the air vents 53 are formed at a position that does not overlap with the control circuit board 71 disposed on the an axially second side of the bracket 50.

The main body 51 has, on its outer edge, a plurality of wiring holes 54. Each of the wiring holes 54 penetrates the main body 51 in the axial direction. The wiring holes 54 are formed in the opposite region from the region where the air vents 53 are densely formed. The wiring holes 54 allow the lead wires drawn from the stator 20 to extend toward the control circuit board 71. In the present embodiment, the number of wiring holes 54 is three corresponding to the number of lead-out positions P1 to P3 on the stator 20. The lead wires passing through the wiring holes 54 are electrically connected to the control circuit board 71. In other words, the motor 2 includes the control circuit board 71 that is electrically connected to the coils 23.

The control circuit board 71 is electrically connected to the bracket 50. The control circuit board 71 is thus connected to the ground via the bracket 50. The control circuit board 71 is electrically connected to the bracket 50 so as to be secured to the bracket 50 with a screw, for example.

The bracket 50 includes a tongue-shaped piece 55 that protrudes from an outer periphery of the main body 51 in the radial direction. The tongue-shaped piece 55 is integrated with the main body 51. The tongue-shaped piece 55 has a mount hole 55a that penetrates the tongue-shaped piece 55 in the axial direction. In the present embodiment, the bracket 50 includes three tongue-shaped pieces 55. The three tongue-shaped pieces 55 are arranged at equal intervals in the circumferential direction. The bracket 50 is mounted to a target, such as a vehicle body, via the three tongue-shaped pieces 55. For example, the bracket 50 is secured to the vehicle body with screws inserted into the mount holes 55a.

The bracket 50 includes a wire lead-out portion 56 that protrudes from the outer periphery of the bracket 50 in the radial direction. The wires 72 to be drawn from the control circuit board 71 are collectively drawn out from the wire lead-out portion 56. In the present embodiment, the wire lead-out portion 56 is integrated with the main body 51. The wire lead-out portion 56 is disposed opposite one of the three tongue-shaped pieces 55.

The motor 2 includes projections 57 that extend from the bracket 50 toward the axially first side. The projections 57 are directly fixed to the cover 60. In the present embodiment, the projections 57 are integrated with the main body 51. The projections 57 are arranged on an outer edge of the axially first-side end face of the main body 51. The projections 57 are located outward of the air vents 53 and the wiring holes 54 in the radial direction. In the present embodiment, the number of projections 57 is three, but may be appropriately changed. The three projections 57 are arranged at equal intervals in the circumferential direction. In the present embodiment, the three projections 57 are respectively equal in circumferential position to the three tongue-shaped pieces 55. This configuration enables a reduction in radial size by the thickness of a housing to be provided originally.

The projections 57 respectively pass through the connection holes 25. The three projections 57 pass through the connection holes 25 to connect the bracket 50 to the stator 20. Each of the projections 57 includes a base portion 571, an insertion portion 572, and a distal end portion 573. The base portions 571 are located on axially second-side ends of the projections 57. The insertion portions 572 extend from the base portions 571 toward the axially first side and are inserted into the connection holes 25. The distal end portions 573 are located on axially first-side ends of the projections 57. The base portions 571 are larger in at least one of a circumferential width and a radial width than the insertion portions 572.

In the present embodiment, the base portions 571 and the insertion portions 572 are each formed in a rectangular parallelepiped or substantially rectangular parallelepiped shape. The base portions 571 are larger in circumferential and radial widths than the insertion portions 572. The base portions 571 protrude from two circumferential ends of the respective insertion portions 572. The base portions 571 also protrude radially outward from the insertion portions 572. Therefore, when the insertion portions 572 are inserted into the connection holes 25, axially second-side ends of the protrusions 26 abut against the base portions 571. In the present embodiment, the pair of protruding walls 26a and the connection wall 26b abut against a corresponding one of the base portions 571. The distal end portions 573 each formed in a rod or substantially rod shape protrude from substantial centers of axially first-side end faces of the insertion portions 572 toward the axially first side.

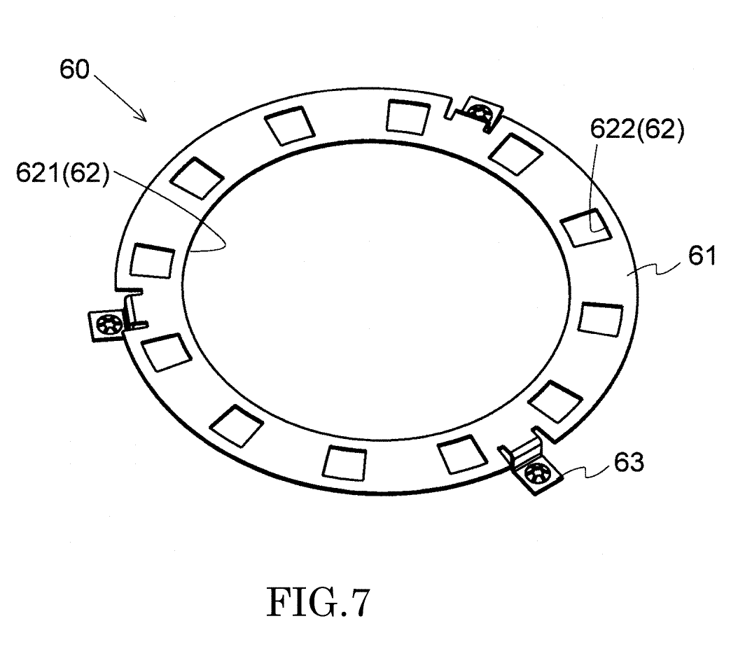

FIG. 7 is a schematic perspective view of the cover 60 according to the embodiment of the present disclosure. The cover 60 includes a flat plate portion 61 that expands in a direction perpendicular to the axial direction. The cover 60 also includes windows 62 that penetrate the cover 60 in the axial direction. In the present embodiment, the windows 62 of the cover 60 include a first window 621 and a second window 622. The number of first windows 621 is one. The second windows 622 are equal in number to the slots 24. The cover 60 is formed of a metal member.

The first window 621 is formed in a circular or substantially circular shape as seen in axial plan view. The first window 621 penetrates the flat plate portion 61 in the axial direction. The flat plate portion 61 is formed in a disk or substantially disk shape, and the first window 621 occupies a wide range covering the center of the flat plate portion 61. The flat plate portion 61 is therefore formed in a ring or substantially ring shape as seen in axial plan view. The central axis A coincides with the center of the flat plate portion 61 as seen in axial plan view. The second windows 622 are formed in an outer periphery of the flat plate portion 61 having the disk or substantially disk shape. The second windows 621 are arranged at equal intervals in the circumferential direction. Each of the second windows 621 is formed in a rectangular or substantially rectangular shape as seen in axial plan view. However, the respective shapes of the first window 621 and second windows 622 may be appropriately changed.

The cover 60 also includes a plurality of fixation portions 63 that are located nearer to the axially second side than the flat plate portion 61 is and are provided to fix the bracket 50. In the present embodiment, the fixation portions 63 are formed on an outer periphery of the flat plate portion 61. The fixation portions 63 are arranged at equal intervals in the circumferential direction. In the present embodiment, the number of fixation portions 63 is three that corresponds to the number of projections 57. Each of the fixation portions 63 is formed by folding a piece multiple times, the piece protruding from the outer periphery of the flat plate portion 61 in the radial direction. The multiple times of folding include folding toward the axially second side. The fixation portions 63 are therefore located nearer to the axially second side than the flat plate portion 61 is. The fixation portions 63 are integrated with the flat plate portion 61.

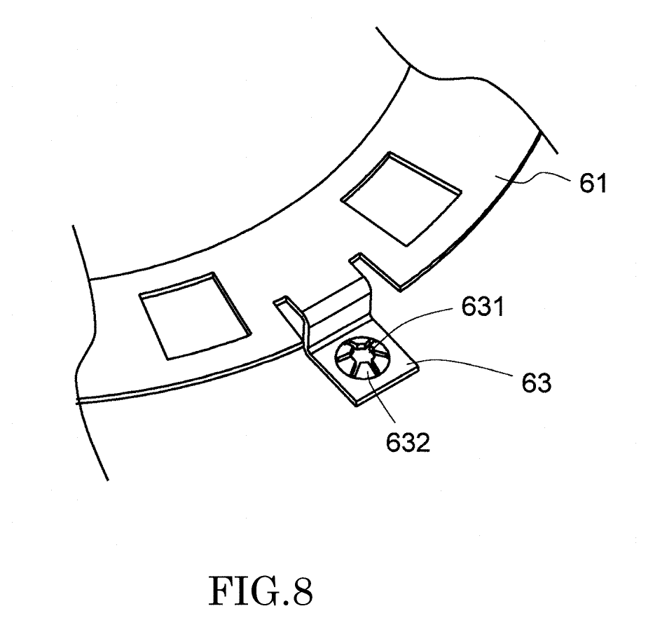

FIG. 8 is an enlarged schematic perspective view of one of the fixation portions 63 of the cover 60 according to the embodiment of the present disclosure. Each fixation portion 63 includes a through-hole 631 and a plurality of pieces 632. The through-hole 631 penetrates the fixation portion 63 in the axial direction. The pieces 632 are disposed around the through-hole 631. The through-hole 631 is at the center of the fixation portion 63 formed in a rectangular or substantially rectangular shape. Each of the pieces 632 is formed in a trapezoidal or substantially trapezoidal shape and is elastically deformable.

The stator 20 is supported by the bracket 50 in such a manner that the projections 57 are respectively inserted into the protrusions 26. In the present embodiment, the projections 57 are fixed by crimping to the protrusions 26 with radially inward force applied to each protrusion 26. The axial position of the stator 20 relative to the bracket 50 is set by abutment of the base portions 571 against the protrusions 26. A clearance is defined between an axially second-side end of each coil 23 and the bracket 50.

The bracket 50 is fixed to the cover 60 in such a manner that the distal end portions 573 are respectively inserted into the through-holes 631. Each distal end portion 573 in the through-hole 631 is pressed against the pieces 632. In the present embodiment, the distal end portions 573 are fixed by crimping to the fixation portions 63. This fixation establishes an electrical connection between the bracket 50 and the cover 60. The cover 60 is connectable to the ground via the bracket 50. The projections 57 and the fixation portions 63 allow fixation of the bracket 50 to the cover 60. This configuration enables a reduction in parts count for fixation and simplifies assembly work.

The fixation portions 63 are located nearer to the axially second side than the flat plate portion 61 is. Even in the state in which the bracket 50 is connected to the cover 60, the distal end portions 573 do not protrude beyond the flat plate portion 61 toward the axially first side. This configuration achieves a reduction in axial size of the motor 2. The axial position of the cover 60 relative to the bracket 50 is set by abutment of the insertion portions 572 with the fixation portions 63. A clearance is defined between an axially first-side end of each coil 23 and the cover 60. The projections 57 are used for connecting the stator core 21 to the bracket 50 and are also used for connecting the bracket 50 to the cover 60. The configuration enables a reduction in parts count of the motor 2, which leads to a reduction in cost.

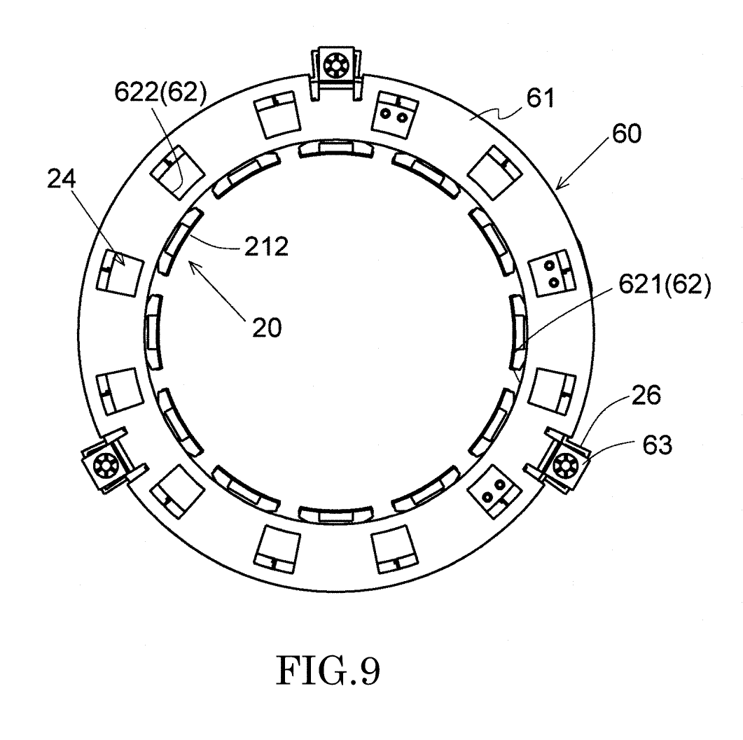

FIG. 9 is a schematic plan view of a relationship between the stator 20 and the cover 60 according to the embodiment of the present disclosure. FIG. 9 illustrates the relationship seen from the axially first side. As illustrated in FIG. 3 and FIG. 9, the windows 62 are located above an axially first side of the rotor 10 and axially first sides of the slots 24. Specifically, the first window 621 is above the axially first side of the rotor 10. The second windows 622 are respectively above the axially first sides of the slots 24. The first window 621 and the second windows 622 are displaced from the axially first-side end faces of the coils 23. The cover 60 covers the axially first-side end faces of the coils 23. The cover 60 covers a region where removal of electromagnetic noise is necessitated, and the windows 62 in the cover 60 ensure air permeability. The windows 62 in the cover 60 also contribute to a reduction in weight of the cover 60 and a reduction in cost.

As illustrated in FIG. 3 and FIG. 4, the clearance between the axially first side of each coil 23 and the cover 60 is continuous in the circumferential direction, and the holder 40 is opened outward in the radial direction. The clearance between the axially second side of each coil 23 and the bracket 50 is also continuous in the circumferential direction, and the holder 40 is opened outward in the radial direction. In other words, the holder 40 has an opening 90 between the axially first-side end of each coil 23 and the cover 60, and an opening 90 between the axially second-side end of each coil 23 and the bracket 50. The openings 90 penetrate the holder 40 in the radial direction. Specifically, the holder 40 has a first opening 91 between the axially first-side end of each coil 23 and the cover 60. The first opening 91 penetrates the holder 40 in the radial direction. The holder 40 also has a second opening 92 between the axially second-side end of each coil 23 and the bracket 50. The second opening 92 penetrates the holder 40 in the radial direction.

The cover 60 and the bracket 50 are connected to each other via the projections 57, but are respectively separated from the stator 20. The first opening 91 and the second opening 92 are therefore defined in the holder 40. The holder 40 includes no sidewall located radially outside the stator 20 to cover an outer periphery of the stator 20. The stator 20 is therefore exposed to the outside of the motor 2.

When the motor 2 is driven to rotate the blades 8, air flows from the axially second side toward the axially first side. Air outside the motor 2 is thus guided to the rotor 10 and the stator 20 through the plurality of air vents 53. The air from the air vents 53 passes through the rotor through-holes 11a and the slots 24. The air from the rotor through-holes 11a and slots 24 is then guided to a region between the cylindrical portion 6 and the stator core 21, through the first window 621 and the second windows 622. The air between the cylindrical portion 6 and the stator core 21 flows from the axially first side toward the axially second side. The air flows out of the motor 2 through a clearance between the holder 40 and the impeller 3. The first opening 91 and the second opening 92 also generate flows of air passing therethrough. In the present embodiment, this configuration prevents the build-up of air in the holder 40. In the present embodiment, the motor 2 is therefore cooled with good efficiency.

In the motor 2, the bracket 50 and cover 60 are collectively connectable to the ground with the coils 23 axially interposed therebetween. This configuration ensures cooling performance and enables removal of electromagnetic noise generated from the coils 23. In the present embodiment, the control circuit board 71 that is electrically connected to the coils 23 is also connectable to the ground via the bracket 50. This configuration improves an effect of removing electromagnetic noise generated from the coils 23. In some cases, the bracket 50 and the cover 60 may be connected to the ground separately from the control circuit board 71.

For example, the electric fan 1 is usable as a fan configured to cool a coolant for an automobile. In this case, the electric fan 1 is installed with the central axis A oriented horizontally. A cooling fan may undergo intrusion of outside moisture. In a conventional structure, a housing has been provided to close a holder 40, which may result in accumulation of moisture in the housing. According to the present embodiment, the first opening 91 and second opening 92 in the holder 40 allow discharge of moisture therefrom. This configuration thus provides a structure capable of avoiding moisture from being accumulated in the holder 40. In other words, this configuration improves draining efficiency of the motor 2.

In the electric fan 1 installed with the central axis A oriented horizontally, preferably, the projections 57 are displaced circumferentially from a position at which the projections 57 each have a lowest vertical height. This configuration prevents moisture from being retained on the projections 57 and further improves a draining effect of the motor 2.

In the foregoing embodiment, the projections 57 electrically connect and fix the bracket 50 to the cover 60. However, this configuration is merely exemplary, and any other means may be employed. For example, bolts may be used instead of the projections 57. The use of the projections 57 that are integrated with the bracket 50 enables a reduction in parts count. The use of the projections 57 that are integrated with the bracket 50 also improves an effect of reducing electromagnetic noise. The use of the projections 57 that are integrated with the bracket 50 also ensures stiffness to be required for connection to the stator 20, with ease.

In the foregoing embodiment, the connection holes 25 are located outward of the core back 211 in the radial direction. However, this configurations is merely exemplary. Alternatively, the connection holes 25 may be located inward of the outer peripheral face of the core back 211 in the radial direction. The connection holes 25 located radially outward of the core back 211 enable effective use of magnetic flux flowing through the stator core 21.

In the foregoing embodiment, the shaft 41 is stationary. Alternatively, the shaft 41 may be rotatable. In this case, the shaft 41 may be fixed to, for example, the resin portion 13. The bearings 30 may be fixed to, for example, the bracket 50 and the cover 60.

The present disclosure is applicable to, for example, an electric fan that cools a coolant for an automobile.

Features of the above-described embodiments and the modifications thereof may be combined appropriately as long as no conflict arises.

While embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor that rotates on a central axis;
a stator that is located radially outside the rotor;
a bearing that supports the rotor such that the rotor is rotatable with respect to the stator; and
a holder that supports the stator,
wherein
the stator comprises:
a stator core; and
a coil that is formed of a conductive wire wound around the stator core,
the holder comprises:
a cover that is disposed on an axially first side of the coil; and
a bracket that is electrically connected to and fixed to the cover, is disposed on an axially second side of the coil, and is connectable to a ground, and
the holder comprises an opening that penetrates the holder in a radial direction and is located between the axially first-side end of the coil and the cover, and an opening that penetrates the holder in the radial direction and is located between the axially second-side end of the coil and the bracket.

2. The motor according to claim 1, further comprising
a control circuit board that is electrically connected to the coil,
wherein
the control circuit board is electrically connected to the bracket.

3. The motor according to claim 1, wherein
the coil is one of a plurality of coils arranged in a circumferential direction,
a slot is defined between two adjoining coils of the plurality of coils,
the cover comprises windows that penetrate the cover in an axial direction, and
the windows are respectively located above an axially first side of the rotor and an axially first side of the slot.

4. The motor according to claim 1, wherein
the bracket comprises a projection that extends toward an axially first side, and
the projection is directly fixed to the cover.

5. The motor according to claim 4, wherein
the stator core has a connection hole that penetrates the stator core in an axial direction, and
the projection passes through the connection hole.

6. The motor according to claim 5, wherein
the stator core comprises a protrusion that protrudes outward from an outer peripheral face of the stator core in the radial direction, and
the protrusion has the connection hole.

7. The motor according to claim 6, wherein
the projection comprises:
a base portion that is located on an axially second-side end of the projection; and
an insertion portion that extends from the base portion toward the axially first side and is inserted into the connection hole,
the base portion is larger in at least one of a circumferential width and a radial width than the insertion portion, and
the protrusion has an axially second-side end that abuts against the base portion.

8. The motor according to claim 1, wherein
the cover comprises:
a flat plate portion that expands in a direction perpendicular to an axial direction; and
a plurality of fixation portions that are located nearer to an axially second side than the flat plate portion is and are provided to fix the bracket.

9. The motor according to claim 8, wherein
each of the fixation portions comprises:
a through-hole that penetrates the fixation portion in the axial direction; and
a plurality of pieces that are disposed around the through-hole.

10. An electric fan comprising:
the motor according to claim 1; and
an impeller that is disposed on an axially first side of the motor and rotates on the central axis of the motor,
wherein
the impeller comprises:
a tubular portion whose axially first side is closed,
the tubular portion being provided to cover at least a part of the motor from a radially outer side of the motor; and
a plurality of blades that are disposed on an outer periphery of the tubular portion and are arranged in a circumferential direction.
